(19) United States
(12) Patent Application Publication
(10) Pub. No.: US 2002/0077098 A1
(43) Pub. Date: Jun. 20, 2002

(54) Method and system for dual ringing of a centrex line and a wireless extension of the centrex line

(76) Inventors: Dianna I. Tiliks, Elk Grove, IL (US); Mary L. Fox, Chicago, IL (US); Wayne R. Heinmiller, Elgin, IL (US); Thomas J. McBlain, Arlington Heights, IL (US); Todd A. Bartels, New Berlin, WI (US); Gordon L. Blumenschein, Woodridge, IL (US)

Correspondence Address: Joseph F. Hetz, Brinks Hofer Gilson & Lione, NBC Tower, Suite 3600, P.O. Box 10395, Chicago, IL, 60610, US

(21) Appl. No.: 09/741,734

(22) Filed: Dec. 19, 2000

(51) Int. Cl. H04Q 7/20

(52) U.S. Cl. 455/426; 455/445; 455/461

(57) ABSTRACT

A method and system are provided for dual ringing of a Centrex line and a wireless extension of the Centrex line. With dual ringing functionality, a single destination number dialed by a calling party results in ringing of both a Centrex line and a wireless extension of the Centrex line. In one preferred embodiment described herein, the dual ringing functionality is implemented with a network element (e.g., a service node) separate from a switch (e.g., a service signal point). In this way, the dual ringing functionality is available to users of any end office switch that uses the separate network element—not only to those users of a particular type of end office switch. Furthermore, unlike switches, network elements, such as service nodes, typically do not require vendor approval for modification. Additionally, the dual ringing functionality of these preferred embodiments is switch independent and provides an open platform.

### TECHNICAL FIELD

The present invention relates generally to call processing in telecommunication networks and specifically to a method and system for dual ringing of a Centrex line and a wireless extension of the Centrex line.

### BACKGROUND

A Centrex system provides features that are normally associated with a Private Branch Exchange (PBX). Unlike a PBX which is located on a user's premises, a Centrex system is provided to a Centrex or business group from a telephone company's central office. Common Centrex features include extension/abbreviated dialing (e.g., dialing a four-digit number instead of a seven-digit number), aggregated billing with flat rate or discount charges, and the ability to control the type of calls made from and received by the Centrex user. When an employee is at his desk using his Centrex station, he receives the benefits of the Centrex features. However, many employees work away from their desks and use a wireless communication device, such as a cellular phone. Unfortunately, the features of the Centrex station are not available to the employee when he is using his wireless communication device.

Recently, wireless Centrex services have been made available to address this problem. With a Wireless Centrex service, the wireless communication device becomes a “wireless extension” of the user's Centrex station so that both the Centrex station and the wireless communication device enjoy the benefits of the Centrex features. One such wireless Centrex system in Nortel Networks' DMS-100 Wireless System. In addition to providing a wireless extension service, this system provides a dual ringing service, which allows a single phone number to ring both the Centrex line and the wireless extension. With the DMS-100 Wireless System, wireline and wireless switching systems are integrated into a single hardware platform, and no external intelligent network platforms or other remote switch peripherals are used. There are several shortcomings associated with this integrated design. First, because the wireless Centrex service is provided by the switch itself, the wireless Centrex service is only available to the users of that switch. Accordingly, the wireless Centrex service is not available to users of central offices with other types of switches. Additionally, because vendor approval is usually required to modify the switch, this wireless Centrex implementation is subject to those problems typically associated with closed systems.

There is a need, therefore, for a method and system for dual ringing of a Centrex line and a wireless extension of the Centrex line that will overcome the disadvantages described above.

### BRIEF DESCRIPTION OF THE DRAWINGS

FIG. 1 is a block diagram of a telecommunication system of a preferred embodiment.

FIG. 2 is a flow chart of a method of a preferred embodiment for dual ringing of a Centrex line and a wireless extension of the Centrex line using an advanced intelligent telecommunication network

FIG. 3 is an illustration of call flows for data traffic in the method of the preferred embodiment shown in the flow chart of FIG. 2.

FIG. 4 is an illustration of call flows for voice traffic in the method of the preferred embodiment shown in the flow chart of FIG. 2.

### DETAILED DESCRIPTION OF THE PRESENTLY PREFERRED EMBODIMENTS

By way of overview, the preferred embodiments described herein relate to a method and system for dual ringing of a Centrex line and a wireless extension of the Centrex line. With dual ringing functionality, a single destination number dialed by a calling party results in ringing of both a Centrex line and a wireless extension of the Centrex line. In one preferred embodiment described herein, the dual ringing functionality is implemented with a network element (e.g., a service node) separate from a switch (e.g., a service signal point). In this way, the dual ringing functionality is available to users of any end office switch that uses the separate network element not only to those users of a particular type of end office switch. Furthermore, unlike switches, network elements, such as service nodes, typically do not require vendor approval for modification. Additionally, the dual ringing functionality of these preferred embodiments is switch independent and provides an open platform.

Before turning to a detailed discussion of the dual ringing embodiments, an overview of a wireless Centrex system is presented.

Wireless Centrex Overview

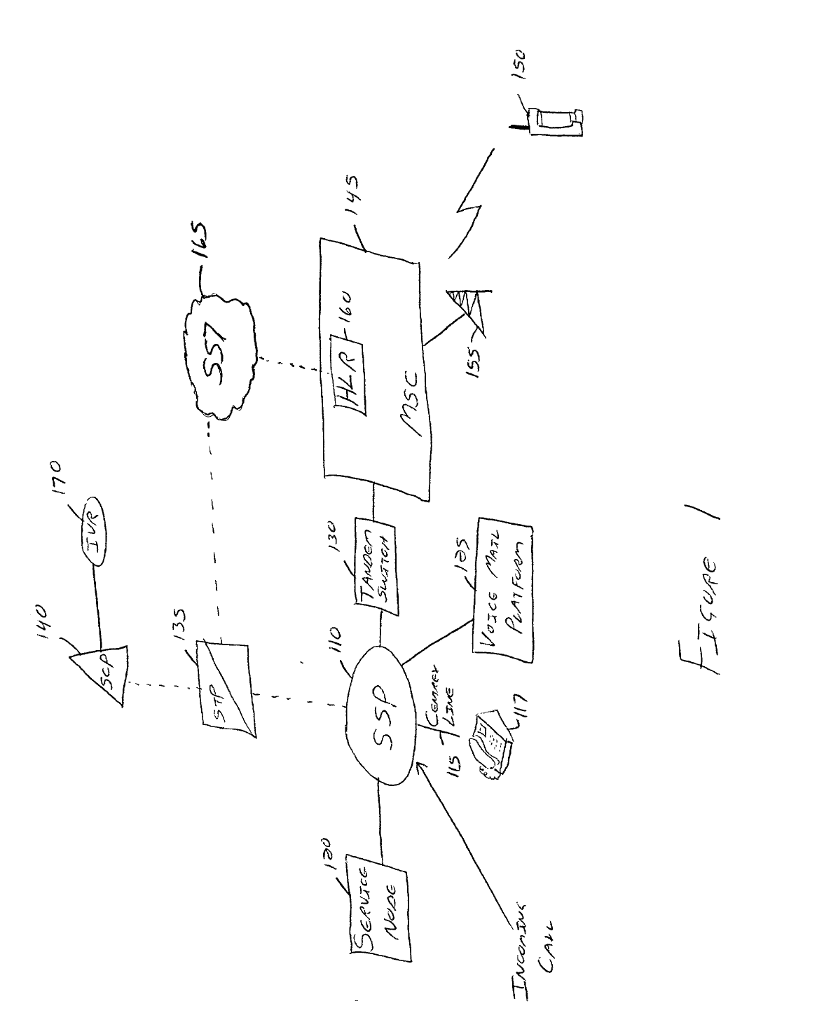

Turning now to the drawings, FIG. 1 is a block diagram of a telecommunication system of a preferred embodiment. It should be understood that the telecommunication system can include elements in addition to the elements shown in FIG. 1. In this preferred embodiment, the telecommunication system takes the form of a public switched telephone network comprising Advanced Intelligent Network (AIN) elements. As shown in FIG. 1, this system comprises a service signal point (SSP) 110 coupled with a service node 120, a signal transfer point (STP) 135, and a service control point (SCP) 140. As used herein, the term “coupled with” means directly coupled with or indirectly coupled with through one or more named or unnamed intermediate components. For example, the SSP 110 is coupled with the SCP 140 through the STP 135. In FIG. 1, signaling data, preferably in the form of Signaling System 7 (SS7) protocol, is shown by dashed lines. In one preferred implementation, the SSP 110 is a Nortel DMS 100 equipped with AIN software release 0.1 or higher, the SCP is a Lucent Advantage SCP, the service node 120 is a Lucent Compact Service Node, and the STP 135 is an Alcatel INfusion STP and/or a Nortel DMS-STP.

SSP 110 is a switch at an end office or central office implementing AIN functionality using SS7 signaling. When the SSP 110 detects a predetermined event, the SSP 110 initiates a trigger, launches a query to the SCP 140, and suspends processing of the call until it receives a reply from the SCP 140. The SCP 140 is a telecommunication network element that can be implemented as a processor running software or implemented exclusively with hardware. The SCP 140 maintains one or more databases that identify services and those users who subscribe to those services. In response to the query from the SSP 110, the SCP 140 queries its database to determine which telecommunication service should be implemented for the call. Based on the results of this query, the SCP 140 instructs the SSP 110 how to process the call. In response to the instruction, the SSP 110 generates additional call signaling messages that are used to set up and route the call.

The SSP 110 is also coupled with the service node 120. The service node 120 is a telecommunication network element that, like the SCP 140, can be implemented as a processor running software or implemented exclusively with hardware. The service node 120 can also include switching devices, voice and DTMF signal recognition devices, and voice synthesis devices and can be used to route a call, collect user input (e.g., DTMF signals or voice commands), and play audio messages. The terms service node, compact service node, resource manager, and intelligent peripheral are used interchangeably herein.

The telecommunication system in FIG. 1 also comprises a tandem switch 130. The tandem switch 130 is coupled with the SSP 110 and a mobile switching center (MSC) 145 of a wireless communication network, preferably via type 2A or 2B trunks. In this way, the tandem switch 130 allows a call to be connected between the public switched telephone network and the wireless communication network. As shown in FIG. 1, signaling data is sent from the public switched telephone system to the wireless communication network via a SS7 data link 165 between the STP 135 and the MSC 145. Preferably, communication between the STP 135 and the MSC 145 is carried out through the SS7 network 165 using IS-41 Transaction Capabilities Applications Protocol (TCAP).

The wireless communication network comprises a broadcast antenna 155 or other suitable device through which the wireless communication device 150 communicates with the MSC 145. The term “wireless communication device” is intended to broadly cover any communication device that receives calls through a wireless, over-the-air connection—not by a line or wire to a telecommunication network element. Wireless communication devices can include, but are not limited to, cellular phones, mobile phones, portable phones, paging devices, and modems adapted to receive wireless transmissions. Personal communication service (PCS) devices can also be used. Wireless communication devices can use any wireless communication technology including, but not limited to, advanced mobile phone systems (AMPS), analog with enhanced registration, time division multiple access (TDMA), code division multiple access (CDMA), global system mobile (GSM) technology, cellular, personal communications services (PCS), and G3 technologies, as well as radio, infrared, and satellite transmissions. Also, as used herein, a wireless communication device is “available” when the wireless communication device is either active (e.g., on) or active and not busy (e.g., idle).

The MSC 145 handles switching and routing to the wireless communication device 150 and keeps track of the wireless communication devices that are associated with the MSC 145 (e.g., the wireless communication devices in its region). Wireless communication devices register with the MSC 145, and the MSC 145 stores the availability information of the wireless communication devices of subscribers served by the MSC 145 in a home location register (HLR) 160. Through the data link between the SCP 140 and the HLR 160, the SCP 140 can query the HLR 160 to determine availability information of the wireless communication device 150. The MSC 145 can also comprise a visitors' location register (VLR) to store availability information of wireless communication devices of subscribers served by other MSCs.

In the embodiment shown in FIG. 1, the telecommunication system implements a wireless Centrex environment, which allows the wireless communication device 150 to be used as a wireless extension of the Centrex line 115. The SSP 110 is assigned to a Centrex line 115 coupled to a Centrex station 117, which can take the form of a wireline/landline telephone, fax machine, computer, or any other suitable customer premises equipment (CPE). The user has the option of using either the Centrex station 117 or the wireless communication device 150 for initiating and receiving calls in a customer premises area. In this preferred embodiment, a limited service area (LSA) is defined for a Centrex customer premises area. When the wireless communication device 150 is inside the LSA, the wireless communication device 150 receives the benefits of the services and billing arrangements associated with the Centrex line 115. Further, by allowing the same directory number and corresponding Centrex extension number to be used by both the Centrex station 117 and the wireless communication device 150, it is as if the same directory number were assigned to both the Centrex line 115 and the wireless communication device 150.

When an outgoing call is placed from the wireless communication device 150 inside the LSA, the MSC 145 routes the call over touch-tone trunks to the SSP 110. Once the call reaches the SSP 110, the call is routed as if it originated from the Centrex station 117. For example, calls made to another Centrex extension while in the LSA can be made using extension dialing, and toll and long distance calls can be routed to the Centrex for least cost routing using remote access or Direct Inward System Access (DISA) ports. Preferably, the MSC 145 converts the digits dialed by the user to a form suitable for the Centrex line 1115. For example, if the user attempts to reach an outside number by dialing “1” plus ten digits, the MSC 145 preferably appends “9” to the dialed digits so that an outside line can be reached.

When an outgoing call is placed from the wireless communication device 150 outside of the LSA, the call is billed under a rate determined by a wireless communication provider, which can be a different rate than that for calls made within the LSA. Even though the wireless communication device 150 is operated outside of the LSA, the user may still be attempting to use Centrex-type features, such as pressing “9” to reach an outside line or extension dialing. Accordingly, it is preferred that the MSC 145 delete the “9” preceding the dialed digits and prefix the NXX on four-digit dialing or NXX-X on three-digit dialing. It may be preferred to provide a tone or other indication to a user when he leaves the LSA to notify the user that the Centrex features will not be available.

Dual Ringing Embodiments

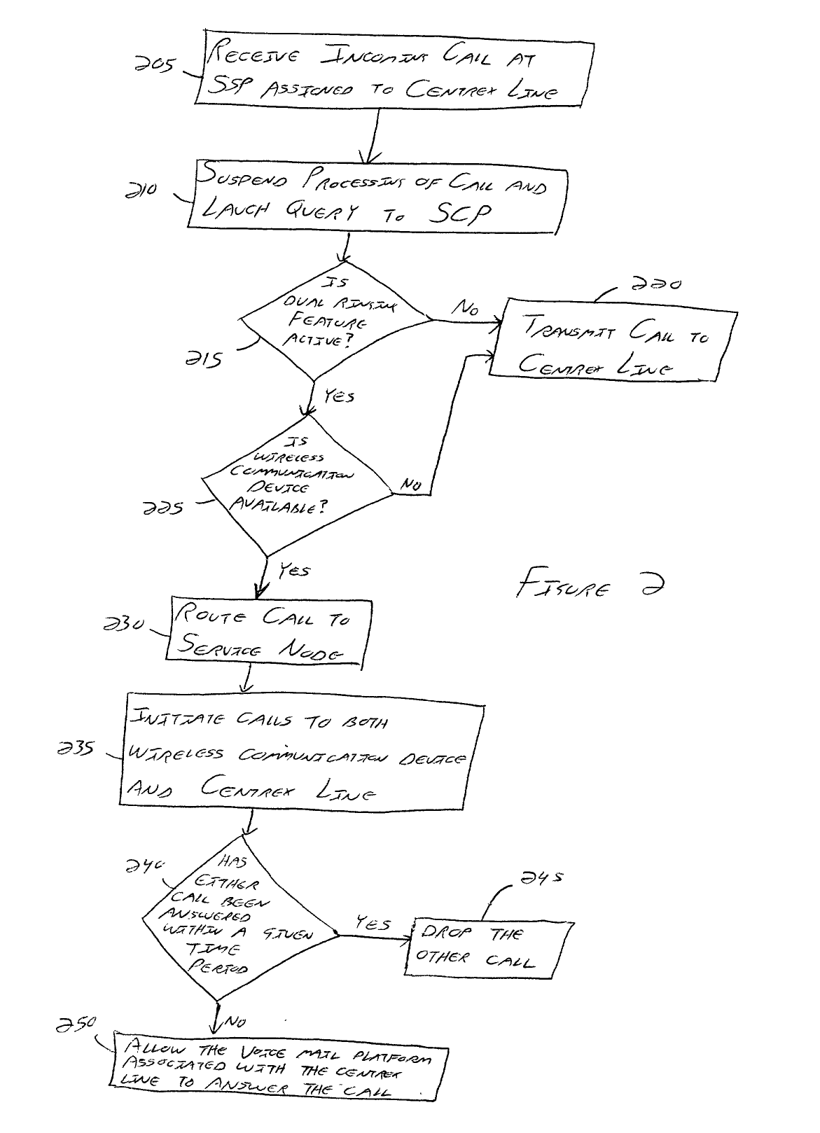

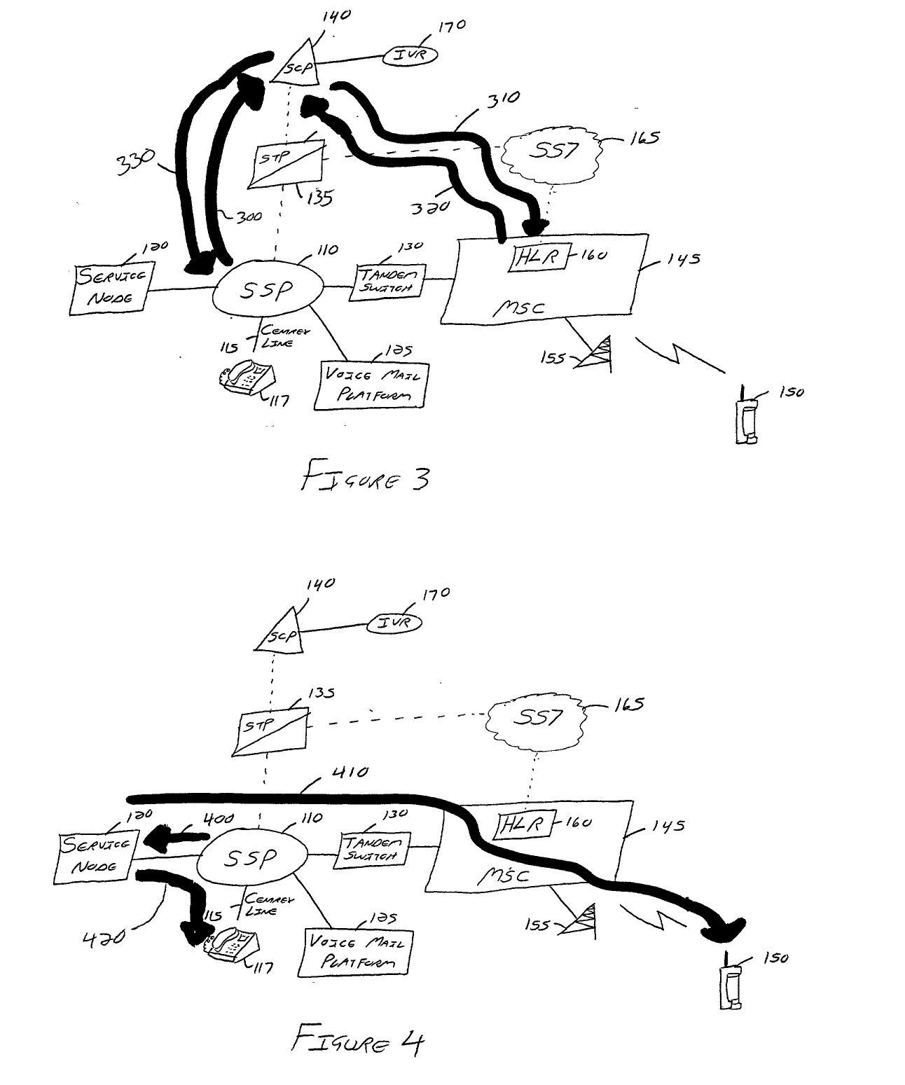

With dual ringing functionality, a single destination number dialed by a calling party results in ringing of both the user's Centrex line and wireless communication device (i.e., his wireless extension). In this way, a single telephone number can be used to reach a person in the LSA regardless of his physical location. Turning again to the drawings, FIG. 2 is a flow chart of a method of a preferred embodiment for dual ringing of a Centrex line and a wireless extension of the Centrex line using the advanced intelligent telecommunication network of FIG. 1. FIGS. 3 and 4 illustrate call flows for data and voice traffic, respectively, and will be discussed in conjunction with the flow chart of FIG. 2. In this illustration, it is assumed that the destination number of the incoming call is that of the Centrex line 115. Further, calls placed to the destination number of the wireless communication unit 150 are assumed to be placed directly to the wireless communication unit 150 (e.g., not through the Centrex service) and, accordingly, are completed to the wireless communication unit 150 without the use of the dual ringing functionality.

First, an incoming call from a calling party is received at the SSP 110 assigned to the Centrex line 115 (act 205). A call can include, for example, voice, data, and/or video communication exchanged between a calling party and a called party. The term “calling party” refers to the party (e.g., person or device, such as a fax machine or computer modem) that initiates a call, and the term “called party” refers to the party to whom the call is directed. The term “user” refers to either the called party or the calling party. The incoming call encounters an AIN terminating attempt trigger (TAT) assigned to the Centrex line. In response to this trigger, the SSP 110 suspends processing of the call and launches a query to the SCP 140 (act 210). This is shown as call flow 300 in FIG. 3. The SCP 140 then determines whether the dual ringing feature is active (act 215). Activating/deactivating the dual ringing feature will be described in more detail below. If the dual ringing feature is not active, the SCP 140 sends a transmit message to the SSP 110, and the SSP 110 transmits the call to the Centrex line 115 (act 220). If the dual ringing feature is active, the SCP 140 determines whether the wireless communication device 150 associated with the Centrex line 115 is available (act 225).

In this preferred embodiment, the dual ringing functionality is executed only if the wireless communication device 150 is available. (In another preferred embodiment, the dual ringing functionality is executed without regard to whether the wireless communication device 150 is available and/or without determining whether the wireless communication device 150 is available.) If the wireless communication device 150 is not available, the call is transmitted to the Centrex line 115 as normal. The SCP 140 makes the determination of whether the wireless communication device is available by sending a message to the wireless network requesting availability information for the wireless communication device 150. One suitable process for determining the availability of the wireless communication device 150 is described in U.S. patent application Ser. No. 09/079,061, “System and Method for Routing a Call to a Called Party's Landline or Wireless Communication Unit,” filed May 14, 1998, which is hereby incorporated by reference. Preferably, the SCP 140 formats the request in a wireless network protocol, such as IS-41, and sends the request to the HLR 160 of the MSC 145 (call flow 310). The HLR 160 returns the availability information to the SCP 140 (call flow 320). If the HLR 160 does not respond to the query within a given time period (e.g., two seconds), it is preferred that the SCP 140 instruct the SSP 110 to transmit the call to the Centrex line 115. Further, if the wireless communication device 150 is not available, the SCP 140 sends a transmit message to the SSP 110, and the SSP 110 transmits the call to the Centrex line 115 (act 220).

If the wireless communication device 150 is available, the SCP 140 routes the call to the service node 120 (act 230). Preferably, the SCP 140 launches a routing message (e.g., a Forward_Call message) with the appropriate AIN parameters to the SSP 10 (call flow 330 in FIG. 3), which routes the call to the service node 120 (call flow 400 in FIG. 4). In this preferred embodiment, the service node 120 implements the dual ringing functionality. The parameters passed to the service node 120 from the SCP 140 instruct the service node 120 to initiate two calls: one to the Centrex line 115 and the other to the wireless communication device 150. Preferably, the service node 120 initiates the two calls simultaneously (or nearly simultaneously, as compared to sequentially). To avoid circular processing of the call, the call from the service node 120 to the SSP 110 preferably does not trigger the query to the SCP 140 described above.

Next, the service node 120 determines whether either of the calls has been answered within a given time period (act 240). When the call to either the Centrex line 115 or the wireless communication device 150 is answered, the other call is dropped by the service node 120 (act 245). In one preferred embodiment, two separate B channels within the same ISDN interface of the service node 120 are used to ring the Centrex line 115 and the wireless communication device 150. When either the Centrex line 115 or the wireless communication device 150 answers the call, the service node 120 preferably drops the other call, and the two in-progress calls on the separate B channels are combined into a single call on one B channel. In an alternate embodiment, calls/channels are combined on separate ISDN interfaces. By using this “2B channel transfer functionality,” the service node 120 is connected to the calling party and whichever Centrex device answered the call. Preferably, the service node 120 drops itself from the call so that it can be used to serve additional calls while the previous call is still underway.

If neither call has been answered within the given time period, the service node 120 drops the call to the wireless communication device 150 and allows the voice mail platform 125 associated with the Centrex line 115 to answer the call and receive a message from the party who originated the incoming call (act 250). This results in a consolidated voice mail mechanism if neither call is answered. To ensure that the voice mail platform 125 receives all messages intended for the Centrex line, it is preferred that the service node 120 monitor the call answered by the wireless communication device 150 to determine whether the wireless communication device's 150 voice mail system has answered the call. If the wireless communication device's 150 voice mail system has answered the call, it is preferred that the connection to the wireless communication device 150 be dropped and that the call be routed to the voice mail platform 125 associated with the Centrex line 115 to answer the call and receive any message. Preferably, calls are routed from the SSP 110 to the voice mail platform 125 using call forward busy/don't answer features. The voice mail platform 125 preferably utilizes a transfer or alias mail box to give the appearance of a unified voice mail platform.

As described above, in one preferred embodiment, the dual ringing feature can be disabled by a user of the Centrex line 115. The user may wish to disable the dual ringing feature, for example, when he is on vacation or temporarily away from work, on the weekends, or at any other time that the user does not wish calls to follow the wireless communication device 150. Any suitable technique to disable/enable the feature can be used. For example, access to the service management system (SMS) of the SCP 140 can be made via an interactive voice response (IVR) system 170, a web-based interface, or a DTMF interface (e.g., to detect a star (*) code). A billing arrangement can be used that discourages de-activating and re-activating the service on a daily basis. Preferably, the service is activated as a default.

There are several advantages associated with these preferred embodiments. First, unlike a wireless Centrex design that is integrated in an end office switch, the dual ringing functionality in these preferred embodiments is implemented with a network element external to the switch. Because of this, the dual ringing functionality is available to users of any end office switch that uses the external network element, not only to those users of a particular type of end office switch. Furthermore, external network elements, such as service nodes, typically do not need vendor approval for modifications. Additionally, because the dual ringing functionality resides in the external network element, the dual ringing functionality is switch independent and provides an open platform.

There are several alternatives that can be employed with these preferred embodiments. In one alternate embodiment, instead of an SSP, a non-SSP central office switch is used in conjunction with additional hardware and/or software components that provide SSP functionality. Additionally, while the preferred embodiments described above show communication between the SCP and the service node going through the SSP, in an alternate embodiment, the SCP and service node communicate without using the SSP. Further, in another alternate embodiment, the SSP transfers voice and data traffic without the use of the tandem switch and transfers network signaling protocols to the SCP without the use of the STP. In yet another embodiment, a distinctive ring or other type of suitable indicator is provided to the wireless communication device to indicate that the incoming call is associated with the Centrex line. Further, while the preferred embodiments were described above in terms of a service node, the dual ringing functionality can also be implemented with any suitable network element/platform/peripheral separate from a switch. For example, a processor separate from a Centrex switch can be used. Also, the dual ringing functionality can be used with or without a Centrex service (e.g., using a non-Centrex landline phone). Lastly, as noted above, the dual ringing functionality is executed without regard to whether the wireless communication device is available and/or without determining whether the wireless communication device is available.

It is intended that the foregoing detailed description be understood as an illustration of selected forms that the invention can take and not as a definition of the invention. It is only the following claims, including all equivalents, that are intended to define the scope of this invention.

What is claimed is:

1. A method for dual ringing of a Centrex line and a wireless extension of the Centrex line using an advanced intelligent telecommunication network comprising a service signal point and a service node, the method comprising:
(a) receiving a call at a service signal point (SSP) assigned to a Centrex line;
(b) routing the call from the SSP to a service node coupled with the SSP; and
(c) with the service node, initiating a first call to a wireless communication device associated with the Centrex line and a second call to the Centrex line.

2. The invention of claim 1 further comprising:
(d) in response to either the first or second call being answered, dropping the other call.

3. The invention of claim 1 further comprising:
(d) if neither the first nor second call is answered within a time period, routing the call to a voicemail system associated with the Centrex line.

4. The invention of claim 1 further comprising determining whether the wireless communication device associated with the Centrex line is available, and wherein (c) is performed only if the wireless communication device associated with the Centrex line is available.

5. A method for dual ringing of a Centrex line and a wireless extension of the Centrex line using an advanced intelligent telecommunication network comprising a service signal point, a service control point, and a service node, the method comprising:
(a) receiving a call at a service signal point (SSP) assigned to a Centrex line;
(b) suspending processing of the call and launching a query to a service control point (SCP) coupled with the SSP;
(c) in response to the query, determining whether a wireless communication device associated with the Centrex line is available; and
(d) if the wireless communication device associated with the Centrex line is available:
(d1) launching a routing message from the SCP to the SSP instructing the SSP to route the call to a service node coupled with the SSP;
(d2) routing the call from the SSP to the service node; and
(d3) with the service node, initiating a first call to the wireless communication device and a second call to the Centrex line.

6. The invention of claim 5 further comprising:
(e) in response to either the first or second call being answered, dropping the other call.

7. The invention of claim 5 further comprising:
(e) if neither the first nor second call is answered within a time period, routing the call to a voicemail system associated with the Centrex line.

8. The invention of claim 5 further comprising:
(e) if the wireless communication device associated with the Centrex line is not available:
(e1) launching a transmit message from the SCP to the SSP instructing the SSP to transmit the call to the Centrex line; and
(e2) transmitting the call from the SSP to the Centrex line.

9. The invention of claim 5, wherein the call received in (a) comprises a destination number assigned to the Centrex line.

10. The invention of claim 5 further comprising, prior to (b), detecting a terminating attempt trigger assigned to the Centrex line.

11. The invention of claim 5 further comprising, prior to (c), determining whether a dual ringing service is enabled.

12. The invention of claim 5, wherein the wireless communication device is part of a wireless network, and wherein (c) comprises sending a request for availability information of the wireless communication device from the SCP to the wireless network.

13. The invention of claim 5, wherein the wireless communication device is part of a wireless network, and wherein (c) comprises:
(c1) sending a request for availability information of the wireless communication device from the SCP to a home location register (HLR) in the wireless network; and
(c2) sending the availability information from the HLR to the SCP.

14. The invention of claim 5, wherein (d3) comprises simultaneously initiating the first and second calls.

15. A system for dual ringing of a Centrex line and a wireless extension of the Centrex line, the system comprising:
a service signal point (SSP) assigned to a Centrex line, the SSP operative to receive a call placed to the Centrex line, suspend processing of the call, and launch a query;
a service control point (SCP) coupled with the SSP, the SCP operative to receive the query launched from the SSP and determine whether a wireless communication device associated with the Centrex line is available; and
a service node coupled with the SSP, the service node operative to initiate a first call to the wireless communication device and a second call to the Centrex line in response to the wireless communication device being available.

16. The invention of claim 15, wherein the service node is further operative to drop the first call in response to the second call being answered and further operative to drop the second call in response to the first call being answered.

17. The invention of claim 15 further comprising a home location register (HLR) coupled with the SCP, wherein the SCP is further operative to determine whether the wireless communication device associated with the Centrex line is available by sending a request for availability information of the wireless communication device to the HLR.

18. A method for dual ringing of a Centrex line and a wireless extension of the Centrex line, the method comprising:
(a) receiving a call at a switch assigned to a Centrex line;
(b) with a network element separate from the switch, initiating a call to the Centrex line; and
(c) with the network element separate from the switch, initiating a call to a wireless communication device associated with the Centrex line.

19. The invention of claim 18, wherein acts (b) and (c) are performed in response to the wireless communication device being available.

20. The invention of claim 18, wherein acts (b) and (c) are performed simultaneously.

21. The invention of claim 18, wherein the network element comprises a service node.

22. The invention of claim 18 further comprising dropping the call to one of the Centrex line or the wireless communication device in response to the other answering the call.
